(19) United States
(12) Patent Application Publication
(10) Pub. No.: US 2018/0106023 A1
(43) Pub. Date: Apr. 19, 2018

(54) ELECTRONICALLY CONTROLLED SANITARY FITTING

(71) Applicant: Franke Water Systems AG, Unterkulm (CH)

(72) Inventors: Stefan Brunner, Moosleerau (CH); Roland Gloor, Zetzwil (DE); Daniel Knupfer, Chur (CH); Thomas Knupfer, Chur (CH)

(73) Assignee: Franke Water Systems AG, Unterkulm (CH)

(21) Appl. No.: 15/554,991

(22) PCT Filed: Mar. 1, 2016
(86) PCT No.: PCT/EP2016/054330

§ 371 Date: Aug. 31, 2017

(30) Foreign Application Priority Data
Mar. 4, 2015 (EP) 15157630.3

(51) Int. Cl. E03C 1/05; G05D 23/13

(52) U.S. Cl. CPC E03C 1/055; E03C 1/0412; G05D 23/1393

(57) ABSTRACT

The operating element (16) of a sanitary fitting has a temperature slide (20) and a flow rate slide (22). These two slides (20, 22) are movable back and forth along a first movement path (40) and a second movement path (42) respectively, in order to set, on the one hand, the temperature of the water and, on the other hand, the flow rate of the water. Sensors (54, 60) detect the location and the position of the temperature slide (20) and of the flow rate slide (22) and deliver corresponding temperature signals and flow rate signals to the electronic controller (56). This controller controls the valve bank (68) in such a way that water with the desired temperature and the set flow rate flows out of the sanitary fitting through the water outlet (28). Square or rectangular designs and a fitting (312) having virtual slide controls (340, 342) are also possible.

### BACKGROUND

The present invention relates to a sanitary fitting.

A sanitary fitting of this type is known from the document WO 2004/081300 A1. It comprises a valve bank with a cold water inlet and a warm water inlet as well as a mixed water outlet. This is connected to a water outlet, through which the water drains, for example into a wash basin. A sensor unit connected to an energy supply comprises at least one proximity sensor, which upon penetration of a person into the detection range of the proximity sensor triggers an action signal to an electronic control connected to the sensor arrangement and the valve bank. The action signal differs in its potential and/or quality from an off signal, which is issued by the proximity sensor without the influence of a person. The control brings the valve bank, by way of detecting and processing a certain number of action signals or by activating the sensor by a time elapsed, into a position matching these signals, causing water to be supplied at a predetermined temperature and/or predetermined flow rate to the water outlet. This sanitary fitting is complicated in its operation and practically cannot be operated intuitively.

### SUMMARY

Therefore the objective of the present invention is to further develop the sanitary fitting of prior art such that it can be easily and intuitively be operated.

This objective is attained in a sanitary fitting with one or more features of the invention.

The sanitary fitting according to the invention comprises a water outlet, a valve bank, an operating part with a sensor arrangement, and an electronic control.

The electronically controlled valve bank is provided with a cold water inlet to be connected to a cold water supply line, a warm water inlet to be connected to a warm water supply line, and a mixed water outlet connected to the water outlet. Based on electrical signals of the sensor arrangement the electronic control adjusts the valve unit, causing cold water, warm water, or mixed water to be supplied with a desired flowrate and/or with a desired temperature to the water outlet.

The operating part comprises a temperature slide, which can be moved manually back and forth along a first trajectory. Further, the operating part comprises a flowrate slide, which can be moved manually back and forth along a second trajectory. The sensor arrangement comprises a stationarily arranged first sensor and an also stationarily arranged second sensor. Depending on the position of the temperature slide the first sensor generates an appropriate electrical temperature signal and the second sensor generates an appropriate electrical flowrate signal depending on the position of the flowrate slide. The control adjusts the valve bank based on this temperature signal and this flowrate signal.

Due to the fact that the operating elements in the form of a temperature slide and a flowrate slide are separated from each other, the electrically controlled sanitary fitting according to the invention can be operated in an extremely simple and intuitive, thus user-friendly fashion.

Suitable valve banks and their adjustment using electronic controls are generally known from prior art, for example also from the document WO 2004/081300 A1.

Preferably the first sensor comprises a Hall-sensor and the temperature slide comprises a permanent magnet, which cooperates with the Hall-sensor. Accordingly, the second sensor preferably also comprises a (separate) Hall-sensor and the flowrate slide also a (separate) permanent magnet, which cooperates with said Hall-sensor.

Hall-sensors are generally known. When a current flows through a Hall-sensor and a magnetic field is applied in a perpendicularly aligned direction thereto, it yields an outlet voltage which is proportional to the product of the magnetic field strength and the current. Accordingly, the permanent magnet of the temperature slide and the permanent magnet of the flowrate slide are arranged such that the magnetic field generated thereby extends as good as possible perpendicularly to the electric current in the Hall-sensor. The closer the permanent magnet to the allocated Hall-sensor the greater the magnetic field strength acting upon the Hall-sensor and accordingly the temperature signal and the flowrate signal, respectively, generated thereby.

Preferably the first sensor comprises several Hall-sensors, which are arranged in a row behind one another in the direction of the first trajectory. Accordingly the second sensor preferably comprises also several (separate) Hall sensors, which in turn are also arranged in a row behind one another in the direction of the second trajectory.

By this embodiment the length of the first trajectory and the active range of motion of the temperature slide, respectively, and the length of the second trajectory and the active trajectory of the flowrate slide, respectively, can be increased in reference to an embodiment comprising only one Hall-sensor. Furthermore, the embodiment with a row of Hall-sensors each allows a gradation of the desired water temperature and the desired water flowrate by allocating a separate Hall-sensor to each stage.

Preferably, no Hall-sensor is provided for cold water alone, so that the control includes no temperature signal either, and thus this valve bank can be controlled such that exclusively cold water can flow to the mixed water outlet.

Accordingly, it is preferred that no Hall-sensor is allocated to the position of the flowrate slide, in which no water shall flow, i.e. an off-position. Accordingly, this control includes no flowrate signal, controlling this valve bank such that neither cold water nor warm water can flow from the respective inlet to the mixed-water outlet.

Preferably the sanitary fitting comprises an electronic circuit, which on the one side is connected to the control and on the other side to the Hall-sensors. This electronic circuit feeds each of the Hall-sensors with a defined current. Further, the voltage obtained from each Hall-sensor is also fed to this circuit, which amplifies these voltages and emits them as the temperature signal and/or flowrate signal to the control. Of course, alternatively it is also possible that the components of the electronic circuit are integrated in the control.

Preferably, the operating part comprises a wall. The temperature slide and the flowrate slide are arranged along one side of this wall in a mobile fashion. The first and the second sensor are arranged on the other side of the wall. This way, on the one side the sensors are protected from environmental influences, and on the other side it is prevented that any contaminants entrained with the slides can damage the sensors.

Preferably the trajectories for the temperature slide and the flowrate slide are provided at the wall. The trajectories can for example be embodied at the wall like dovetails. The wall is preferably made from plastic as an injection-molded p art.

Preferably the wall is located at least approximately in a horizontal level and the guides are embodied on the bottom of said wall. This prevents the deposition of contaminants in the guides.

Preferably the water outlet and the operating part are allocated to a common fitting housing. However, it is also possible for the water outlet to be arranged at a separate outlet housing, while the operating part is arranged in and/or at a separate operating housing.

Preferably the electronic control and the valve bank are located outside of said housing. However, if another above-mentioned electronic circuit is present, it is preferably arranged in the fitting housing and/or in the operating housing.

In the event a common fitting housing is allocated to the water outlet and the operating part, it preferably comprises a base part as well as a separate head part fastened at said base part. A closed sealing element is allocated to this head part, which prevents the penetration of liquid and contaminants into the interior of the fitting housing, particularly of the head part. The sensor arrangement is arranged on the interior of the head part and thus inside the fitting housing, and the temperature slide as well as the flowrate slide are arranged on the exterior of the head part facing the environment and thus the fitting housing.

Preferably the head part comprises a lower cover plate, which cooperates with the sealing element and closes the head parts towards the bottom.

The wall is preferably formed by a guide element, at which the temperature slide and the flowrate slide are guided. Preferably the guide element is inserted in an upper cover of the head part, sealing in the circumferential direction. In this latter embodiment the sealing element preferably cooperates with the guide element.

Preferably the sanitary fitting comprises a temperature limit which prevents that the mixed water can flow out with a temperature which is higher than a predetermined, desired mixed water temperature.

This way it is possible that the temperature limit restricts the path of the temperature slide. It is also possible for the temperature limit to be integrated in the electronic control. Further, it is possible to monitor the mixed water temperature via a thermostat.

It is possible to provide the off-position of the flowrate slide at least approximately in the longitudinal center of the second trajectory. The flowrate slide can move, starting from the off-position, in both opposite directions. Based on the flowrate signal obtained from the second sensor the electronic control adjusts the valve bank such that the mixed water is supplied to one or the other of two water outlets. Preferably, in this case the valve bank comprises a pilot valve, which feeds the mixed water to the desired water outlet.

In the alternative embodiment, instead of mechanic slides, virtual slides using an optical display are used for the temperature slide and the flowrate slide. For this purpose the operating part comprises at least one optic display for illustrating a virtual temperature slide that can move back and forth along a first trajectory as well as a virtual flowrate slide that can move back and forth along a second trajectory. The sensor arrangement of the operating part comprises a first contact sensor arranged along the first trajectory, which detects finger contacts which serve to displace the virtual temperature slide via a first contact motion, and which generates an appropriate electrical temperature signal depending on a position along the first trajectory at which the first contact motion ends. Additionally, the sensor arrangement comprises a second contact sensor arranged along the second trajectory, which detects finger contacts which serve to displace the virtual flowrate slide via a second contact motion and which generates a respective electrical flowrate signal depending on the location along the second trajectory, at which the second contact motion ends. Similar to the first embodiment, the control is here embodied to adjust the valve bank based on the temperature signal and the flowrate signal.

The virtual temperature slide and flowrate slide can for example be indicated in the form of light displays or as stylized, graphically illustrated operating elements. In particular, the optic display can be implemented together with the sensor arrangement in the form of a touch-sensitive display, a so-called touchscreen. The operation occurs in this case by “drawing” the displayed graphic symbol with the finger over the touchscreen. Such a touchscreen can particularly be embodied as a capacitive or resistive touchscreen. In particular, such a touchscreen can be embodied to detect contact motions made with a finger.

When a user contacts one of the graphically or visually displayed operating elements, thus either the virtual temperature slide or the virtual flowrate slide and “draws” it by an appropriate movement of the finger along the corresponding trajectory, the indicated graphic symbol and/or the light display follows the finger movement to the location at which the contact motion ends. Depending on this location an appropriate flowrate or temperature signal is generated which serves to adjust the valve bank.

### BRIEF DESCRIPTION OF THE DRAWINGS

The invention is described in greater detail based on the exemplary embodiments shown in the drawing. It shows in a purely schematic fashion:

FIG. 1 in a perspective view a fitting housing of a sanitary fitting according to the invention with a water outlet as well as a temperature slide and a flowrate slide for selecting the water temperature and/or the water flowrate;

FIG. 2 the parts of the sanitary fitting shown in FIG. 1 in a front view;

FIG. 3 the sanitary fitting according to the invention in a vertical cross-section along the line A-A and in a horizontal section along the line B-B of FIG. 2, as well as an electrical control and a valve bank adjusted thereby;

FIG. 4 the part of the sanitary fitting shown in FIGS. 1 and 2 in a top view, with the double arrows indicating the motion ranges of the temperature slide and the flowrate slide;

FIG. 5 enlarged in reference to FIG. 3 the detail marked V with a permanent magnet in a flowrate slide and Hall-sensors allocated thereto;

FIG. 6 in the same illustration as FIG. 1 an embodiment in which the temperature slide and the flowrate slide can be moved along a straight trajectory;

FIG. 7 in the same illustration as FIG. 1 an operating arrangement with the temperature slide and the flowrate slide;

FIG. 8 a vertical section through the operating arrangement;

FIG. 9 a horizontal section through the operating arrangement and the electronic control as well as the valve bank adjusted thereby, with a mixed water line starting there leading to a water outlet arranged in a separate outlet housing;

FIG. 10 a horizontal section through the head part and the operating arrangement along the line X-X of FIG. 3 with a sealing element;

FIG. 11 a third exemplary embodiment for a fitting with a temperature slide and a flowrate slide;

FIG. 12 a fourth exemplary embodiment for a fitting with a temperature slide and a flowrate slide; and

FIG. 13 a fifth exemplary embodiment in which the temperature slide and the flowrate slide are embodied as virtual display elements in the form of a light display that can be moved via touch sensors.

### DETAILED DESCRIPTION OF THE PREFERRED EMBODIMENTS

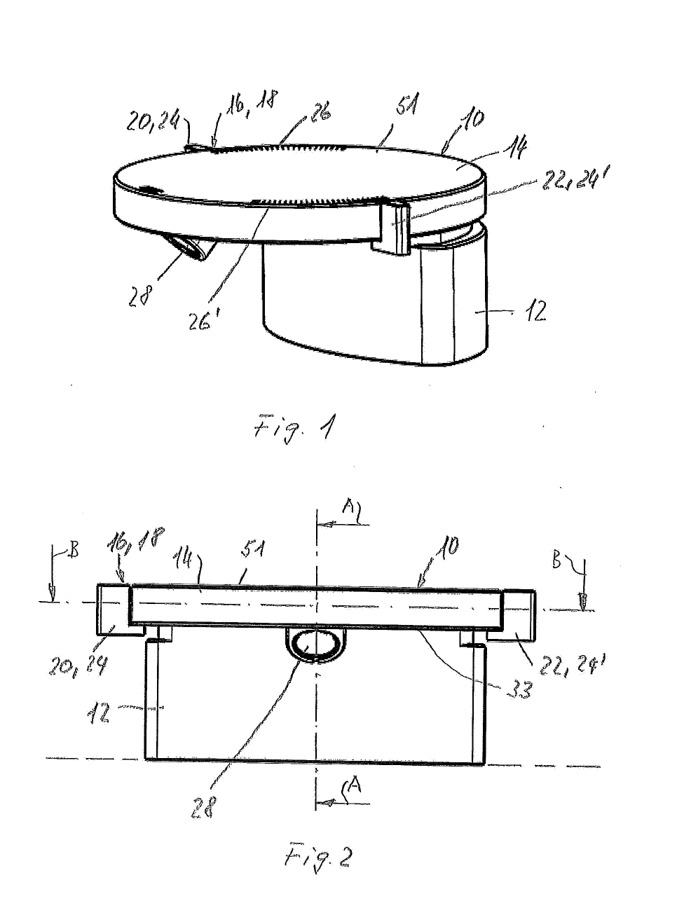

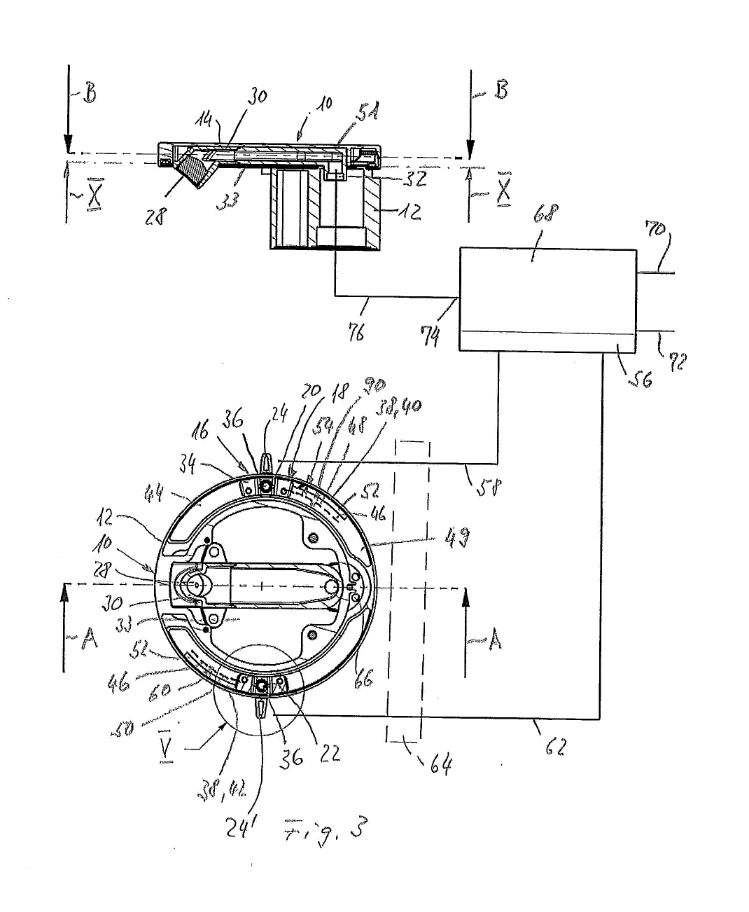

As discernible from FIGS. 1 and 2, the electronically controlled sanitary fitting in the embodiment shown here comprises a fitting housing 10 with a base part 12 and a head part 14 arranged thereon. The base part 12 is intended for fastening to a support, for example a sink. The head part 14 has the form of a circular cylinder with a height measuring less than the diameter. An operating part 16 is arranged at and/or in it comprising a sensor arrangement 18, which is described in greater detail in the context with FIGS. 3 and 5.

The operating part 16 comprises a temperature slide 20 and a flowrate slide 22. FIGS. 1 and 2 show the operating lever 24 and/or 24′ of these slides 20, 22. The operating levers 24, 24′ can be moved back and forth along the casing area of the head part 14.

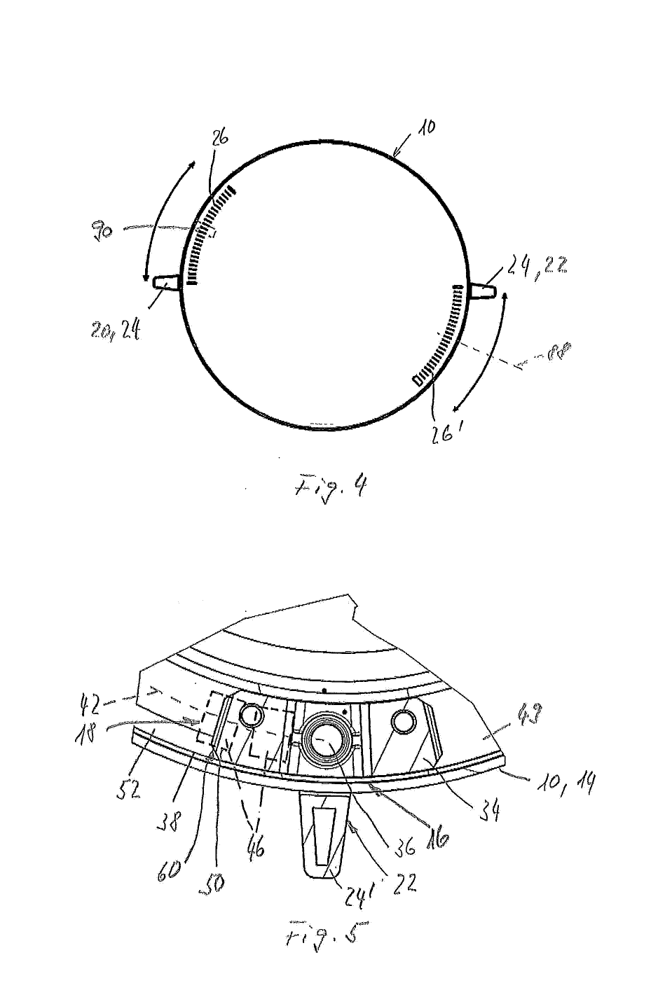

Scales 26 and 26′, respectively, are each located on the top of the head part 14, both for the temperature slide 20 as well as for the flowrate slide 22. They also indicate the range of motion of the actuation levers 24, 24′, which are indicated in FIG. 4 with double arrows. The two scales 26, 26′ are arranged diametrically opposite the head part 14.

The base part 12 embodied like a cylinder assumes at the rear the form of the head part 14, while at the front it is flattened and extends approximately to the center of the head part 14. The head part 14 therefore protrudes at the front beyond the base part 12 and comprises at its bottom, in the exposed end section, a water outlet 28 in which preferably an aerator (Perlator®) is arranged.

For reasons of completeness it shall be mentioned that the base part 12 is embodied at the rear in its upper end section with a cross-section that tapers like a shoulder in order to ensure that the movement of the temperature slide 20 is not hindered.

For reasons of clarity, FIG. 3 shows at the top the fitting housing 10 with its installations in a vertical section and at the bottom it shows the head part 14 in a horizontal cross-section.

A flow element 30 is located inside the head part 14, which on the one end comprises a line connection 32 projecting in the bottom direction towards the base part 12 and on the other end an end section pointing diagonally downwards, by which the flow element 30 projects under the head part 14 and/or the lower cover plate 33 of the head part 14 and which forms the water outlet 28.

It may comprise two parts assembled in a sealing fashion.

As particularly discernible from the horizontal cross-section, the temperature slide 20 and the flowrate slide 22 are embodied identically. Their design is shown enlarged in FIG. 5. The two slides 20, 22 each comprise a sled 34, which is connected fixed to the respective operating lever 24, 24′, preferably being formed integrally in one piece with it.

A permanent magnet 36 is arranged in each sled 34, with its magnetic field extending in the vertical direction into the face located above.

Each of the two sleds 34 is guided in a sliding fashion in a separate guide 38, embodied for example like a dovetail. The guides 38 define a first trajectory 40 for the temperature slide 20 and a second trajectory 42 for the flowrate slide 22.

In the exemplary embodiment shown the first and second trajectory 40, 42 show the form of an arc and extend coaxially in reference to the jacket of the head part 14.

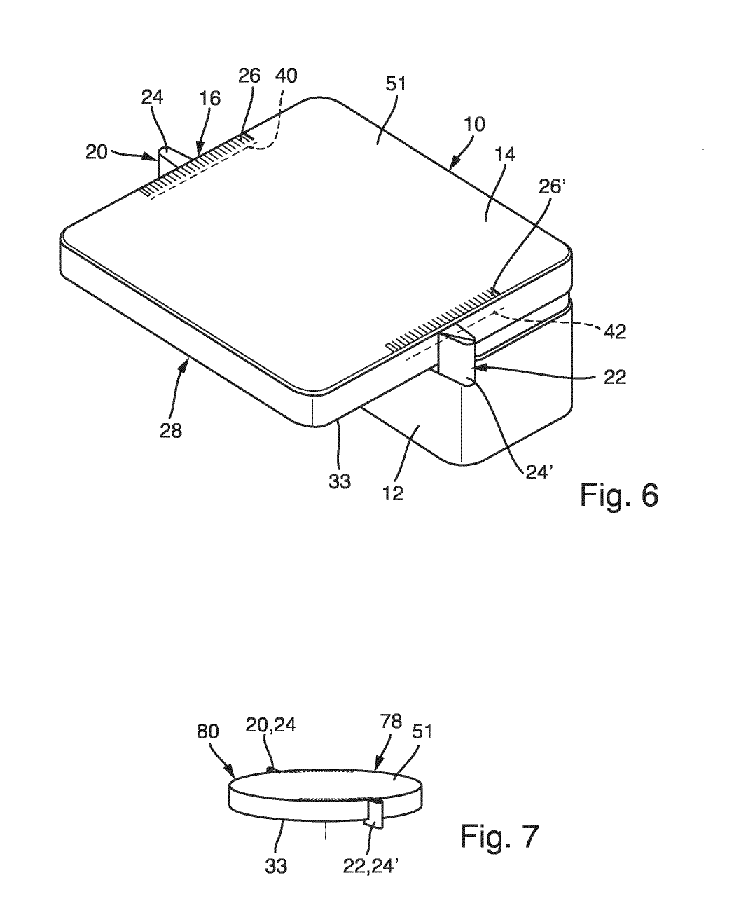

The trajectory 40, 42 can also extend in a straight fashion, see FIG. 6.

The guides 48 are embodied on the bottom of a wall 44 of the head part 14. Hall-sensors 46 are arranged in a stationary fashion on the top of this wall and thus inside the head part 14. A first row 48 of Hall-sensors is allocated to the temperature slide and a second row 50 of Hall-sensors 46 to the flowrate slide 22.

The wall 44 is here embodied at a circular guide element 49, which is inserted in an upper cover 51 of the fitting housing 10 in a circumferentially sealing fashion. The upper cover comprises a cover plate forming the top, here in a planar fashion, from which a casing wall projects downwards at the perimeter. The guide element 49 is connected thereto in a sealing fashion, for example by way of adhesion.

FIG. 3 shows the temperature slide 20 in the cold water position. Starting from this position it can be moved in the clockwise direction along the first trajectory 40, with its permanent magnet 36 successively overlapping the individual Hall-sensors 46 of the first row 48 and thus cooperating therewith. The range of motion of the temperature slide 20 is limited by a groove 52 in the wall 44, with a projection of the temperature slide 20 penetrating into said groove 52. If the temperature slide 20 is located at the end of the first trajectory 40 distant from the cold water position here it assumes the warm water position. It now can be moved back and forth by hand between these end positions and can be fixed in intermediate positions in order to select a mixed water temperature.

The same applies accordingly to the flowrate slide 22. FIG. 3 shows the flowrate slide 20 in the off-position, which means that no water shall flow out of the sanitary fitting. When the flowrate slide 22 is positioned (in the clockwise direction) at the other end of the second trajectory 42, it is set to the maximum flowrate position. The flowrate slide 22 can be moved back and forth between these two end positions, in order to allow adjusting gradually the water flowrate according to the second row of Hall-sensors 46.

The first row 48 of Hall-sensors 46 forms a first sensor 54, which generates electrical temperature signals depending on the location and/or the position of the temperature slide 20 and issues it to an electronic control 56 via an electric line 58.

Accordingly, the second row 50 of Hall-sensors 46 forms a second sensor 60, which based on the location and/or the position of the flowrate slide generates an electrical flowrate signal and issues it via another electric line 62 also to the electronic control 56.

The current for feeding the Hall-sensors 46 is here provided by the electronic control 56. The control of the current for each of the Hall-sensors 46 can occur by the electronic control 56 and an appropriate number of feed lines to the Hall-sensors 46. However, preferably a schematically indicated, electronic circuit 64 is provided in the head part 14 of the fitting housing 10, which is fed by the control 56 and which feeds each of the Hall-sensors 46 with a certain current.

The voltage of the Hall-sensors 46, which determines the temperature signal and the flowrate signal, respectively, is tapped and preferably fed to the electronic circuit 64 in an amplified fashion and then forwarded via the lines 58 and/or 62 to the control 56.

FIG. 3 indicates only schematically these lines and the electronic circuit 64. They extend from the electronic control 56 through the base part 12 to the head part 14, which has line conduits 66 for this purpose.

Preferably the Hall-sensors 46 and the respective electric lines as well as the electronic circuit 46 are arranged on a printed plate or a so-called flexprint, which is inserted in the head part 14. Then a cable leads therefrom to the control 56.

Of course, the wall 44 is made from a material, preferably a synthetic material, which has no influence upon the magnetic field of the permanent magnets 36.

The electronic control 56 adjusts the valve bank 68, which is generally known. It comprises a cold water inlet 70, a warm water inlet 72, and a mixed water outlet 74. The latter is flow-connected to the water outlet 28 via a mixed water line 76, which is connected to the line connection 32. The cold water inlet 70 and the warm water inlet 72 are intended for a connection to a cold water feed line and/or a warm water feed line.

As known from the publication WO 2004/081300 A1, the electronic control 56 preferably comprises a processor, which adjusts the valve bank 68 via a computer program such that the temperature and the flowrate of the water leaving the sanitary fitting at the water outlet 28 match the position of the temperature slide 20 and the flowrate slide 22.

While in the embodiment shown in FIGS. 1 to 5 the temperature slide 20 and the flowrate slide 22 are moved along the arced trajectory 40, 42, FIG. 6 shows an embodiment of the sanitary fitting in which the first trajectory 40 and the second trajectory 42 extend in a straight fashion. Here the base part 12 has a rectangular cross-section with rounded edges and the head part 14, seen in a top view, shows a square shape with rounded edges. The water outlet 28 is here also provided at the bottom of the head part 14. The design and the functionality are precisely the same as described above, with the first trajectory 40 and the second trajectory 42 having defined guides 48 for the temperature slide 20 and the flowrate slide 22, which are embodied in a straight line, and the first row 48 as well as the second row 50 of the Hall-sensors 46 also extending in a straight line. Here, the guide element 49 is formed in a square fashion.

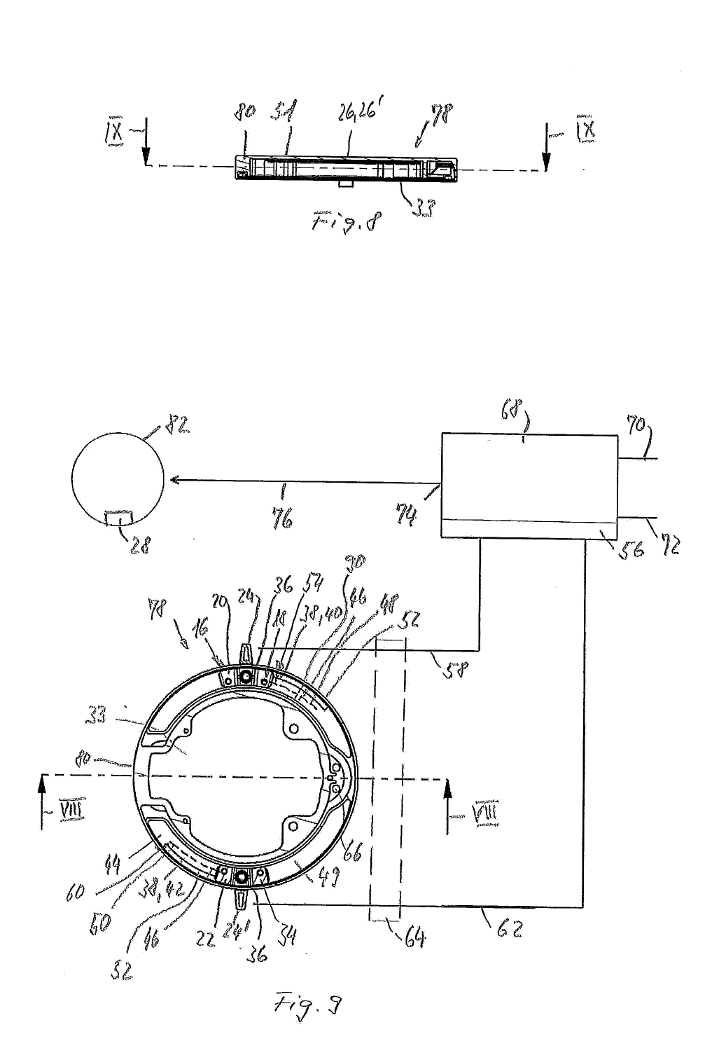

Another embodiment of the sanitary fitting according to the invention is shown in FIGS. 7 to 9. In the operating part 78 according to the head part 14 a separate operating housing 80 is provided, which is embodied similar to the head part 14 but without a flow element 30 and a water outlet 28. It comprises the upper cover 51 with the jacket wall. The guide element 49 is inserted with its circumference, i.e. similar to the other embodiments, with the jacket wall in the upper cover 51 in a sealing fashion. The lower cover 33 seals the operating housing 80 in a sealing fashion towards the bottom.

In this embodiment the valve bank 68 is connected via the mixed water line 76 to a water outlet 28 which is arranged in a separate outlet housing 82 separated from the operating housing 18. The operating part 16 and the sensor arrangement 18 are arranged in the operating housing 80 in the very same fashion as described in the context with FIGS. 1 to 5.

The first sensor 54 and the second sensor 60 are also connected via electric lines 56, 62 to the electronic control 56 which adjusts the valve bank 68 as described above.

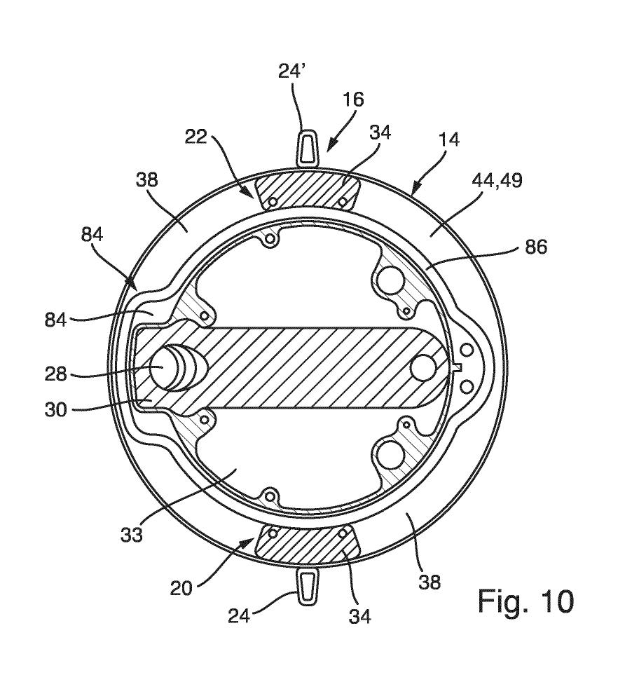

As illustrated in FIG. 10, the guide element 49 has two wall elements 84 projecting from the wall 44 towards the bottom and extending at a constant distance from each other, which are self-contained and form a receiving channel or a self-contained sealing element 86, which is preferably embodied as a flat seal.

The sealing element 86 projects beyond the wall element 84 in the non-compressed state and thus also beyond the receiving channel. During the assembly of the head part 14 the sealing element 86 contacts the lower cover plate 33 and is compressed by the guide element 49 and the lower cover plate 33 being pulled towards each other, for example via screws, in order to exert a sealing effect.

The sealing element 86 prevents the penetration of liquid and contaminants into the interior of the fitting housing 10, particularly the head part 14, in which the sensor arrangement 18 and perhaps the electronic circuit 64 is arranged.

The sealing element 86 extends radially inwardly with regards to the temperature slide 20 and the flowrate slide 22 as well as the corresponding guides 38. The temperature slide 20 and the flowrate slide 22 are therefore arranged on the exterior of the head part 14 facing the environment and thus the fitting housing 10.

As indicated in FIG. 4 with a dot-dash line, it is also possible to provide the off-position 88 for the flowrate slide 22 at least approximately in the longitudinal center of the range of motion of the flowrate slide 22. This particularly applies for a sanitary fitting for bathtubs and overhead/hand-held shower heads. Based on the off-position 88, for example by moving the flowrate slide 22 in the counter-clockwise direction, the water flow can be increased for the overhead/hand-held shower head, with the maximum flowrate being yielded when the flowrate slide is located at the respective end of the range of motion. Accordingly, starting from the off-position 88 and by moving the flowrate slide 22 in the clockwise direction, the water flowrate can be increased for the bathtub with the maximum flowrate being reached when the flowrate slide is located at the respective end of the range of motion.

In this embodiment it is advantageous to provide a latch element in the off-position 88, requiring its force to be overcome in order to displace the flowrate slide 22 out of the off-position 88 in one or the other direction. The user also senses in this embodiment when the off position has been reached.

In this embodiment, no Hall-sensor 36 is located in the off-position 88 and a row of Hall-sensors 36 is allocated respectively to the range of motion of the overhead/hand-held showerhead as well as the range of motion for the bathtub as described above.

A pilot valve is allocated to the valve bank 68 in this embodiment, which at the inlet side is connected to the mixed water outlet 74 and at the outlet side is connected at the one side via a mixed water line 76 to the water outlet 28 formed at the overhead/hand-held showerhead and on the other side via another mixed water line 76 to the water outlet 28 formed at the bathtub outlet.

The electronic control 56 adjusts additionally the pilot valve according to the position of the flowrate slide 22. For the rest, the design and the functionality of this embodiment is equivalent to each of the other embodiments described above.

Here, too, it is possible to provide linear trajectories 40, 42 for the flowrate slide 22 and the temperature slide 20.

It is further possible to provide a temperature limit 90 in all embodiments, preferably the just described ones. This temperature limit 90 can be formed for example by a mechanical limiting element which can be arranged for example at the fitting housing 10 or the guide 38 of the temperature slide 20, for example by way of latching. It limits the motion of the temperature slide 20 beyond the desired temperature permitted.

It is also possible to form the temperature limit 90 by an elastically arranged latch element at the temperature slide 20, which cooperates with a recess (or projection), for example in the wall 44, allocated to the desired temperature permitted. Here it is possible that the temperature slide 20 can be moved intentionally by a greater force beyond the position allocated to the desired temperature permitted.

Finally it shall be mentioned that it is also possible to program the electronic control 56 such that mixed water can flow maximally with the desired temperature permitted through the mixed water outlet 74. In this case the temperature limit 90 is integrated in the electronic control 56.

It is also possible to provide a flowrate limit. This may be embodied similar to the temperature limit 90. In the event the flowrate limit is integrated in the electronic control 56 it controls the valve bank 68 such that the water flowrate is limited to a certain maximum value.

For reasons of completeness it shall be mentioned that of course an electric energy supply is provided in order to feed all electrical and electronic components. This may occur for example via a power pack which is connected to the electric building connector to the grid.

Of course it is also possible to use other generally known sensors instead of the Hall-sensors 46 in order to detect the location and/or position of the temperature slide 20 and the flowrate slide 22 and to generate respective electrical temperature signals and/or flowrate signals, which are fed to the electronic control 56.

The present invention also relates to an operating unit 78 and a sanitary fitting with an operating unit 76 comprising an operating part 16 showing a sensor arrangement 18, with the operating part 16 comprising a temperature slide 20 that can be moved manually back and forth along a first trajectory 40 as well as a flowrate slide 22 that can be moved manually back and forth along a second trajectory 42 and a sensor arrangement 18 with a first sensor 54, which depending on the location and/or the position of the temperature slide 20 generates a respective electrical temperature signal as well as a second sensor 60 which depending on the location and/or positon of the flowrate slide 22 generates a respective electrical flowrate signal.

The temperature signal and the flowrate signal are issued to the electronic control 56. This control then adjusts the valve bank 68.

Preferably the operating unit is formed according to one of claims 2 to 6.

Preferably the operating unit 78 comprises an operating housing 80, with the operating part 18 being arranged in and/or at it.

As indicated in FIG. 7 with dot-dash lines, the operating unit 78 can be fastened to a wall or a support, such as a table.

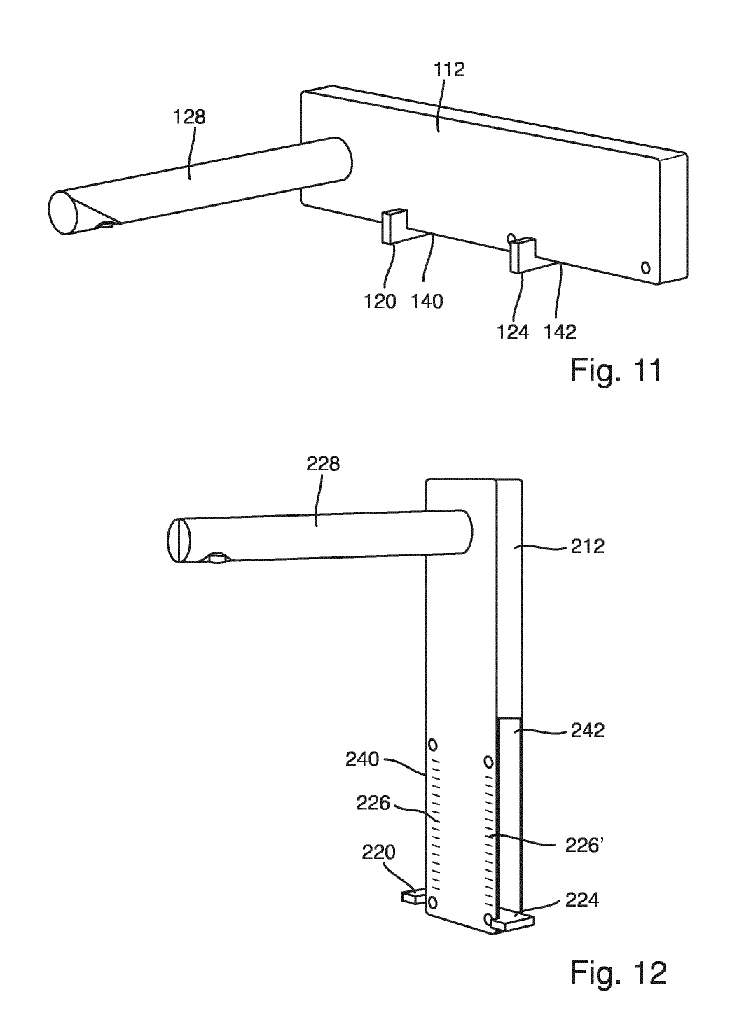

FIGS. 11 and 12 show two additional exemplary embodiments for fittings with temperature slides and flowrate slides. FIG. 11 shows a wall-mounted fitting with a base part 112, an outlet 128, as well as a temperature slide 120 and a flowrate slide 124. Here it is essential that the trajectory 140 of the temperature slide 120 as well as the trajectory 142 of the flowrate slide 124 are both arranged in a line at the bottom edge of the base part 112.

The exemplary embodiment shown in FIG. 12 illustrates a standing fitting that can be fastened for example on a wash basin, a kitchen sink, or a countertop. The base part 212 is here embodied as an upright standing, cuboid column, with in the upper section thereof the outlet 228 being arranged at a right angle. Laterally, respectively at the left and the right of the base part 212 there are at the left the temperature slide 220 and at the right the flowrate slide 224, which are arranged such that they can move up and down in the respective trajectories 240, 242. At the front of the base part 212 respectively a temperature scale 226 and a flowrate scale 226′ are applied. Characteristic in this exemplary embodiment is on the one hand the vertical direction of motion of the temperature slides and flowrate slides 220, 224 and on the other side the symmetrical arrangement at opposite sides of the base part 212.

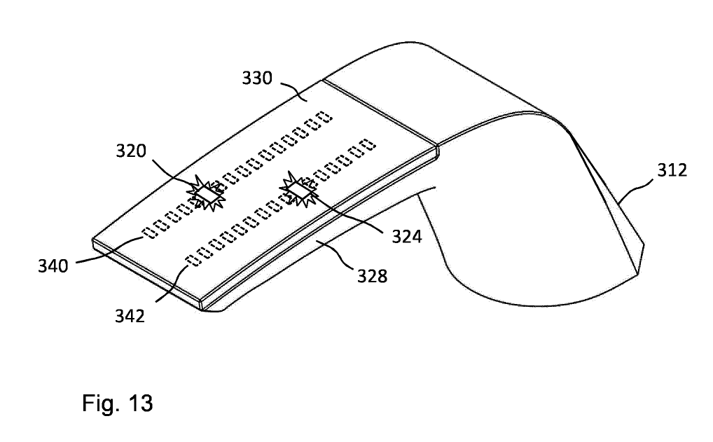

FIG. 13 finally shows another exemplary embodiment for an electronically operated fitting. The operation of the fitting occurs via virtual, i.e. graphic or optically shown operating elements 320, 324. The fitting shows a curved base part 312, at which an outlet 328 is formed. A display 330 with integrated touch sensors is located at the top of the outlet 328.

The display 330 is divided into two virtual trajectories 340, 342, along which respectively a row of light elements is arranged, such as LEDs. In order to visualize a virtual operating element respectively one LED is lit along the corresponding trajectory. The LED 320 lit of the left trajectory 340 displays here a temperature slide, the LED 324 lit of the right trajectory 342 displays a flowrate slide.

The operation occurs such that a user places a finger onto the lit LED 320, which represents the temperature slide, or the lit LED 324, which represents the flowrate slide, and then can move the respective light display along the trajectory 340 and/or 342 upwards or downwards. For this purpose, at the bottom of the display 330 capacitive contact sensors are arranged, which detect any finger contact and via control circuits included in the display 330 adjust the light element such that the light display follows a finger motion along the trajectory 340 and/or 342. Thus, the light element presently located underneath the fingertip is respectively turned on and the previously activated light element is turned off. This way, via a contact motion the virtual temperature slide 320 can be moved along the trajectory 340 upwards or downwards in order to increase the water temperature or to lower it or to move the virtual flowrate slide 324 along the trajectory 342 upwards or downwards in order to increase or reduce the flowrate of the outflowing water.

Similarly, instead of a display with discrete light elements, here a so-called touchscreen, thus a touch-sensitive display can be used, on which graphic symbols representing a flowrate slide and/or temperature slide are moved upwards or downwards on predetermined trajectories.

1. A sanitary fitting comprising a water outlet (28), an electrically controlled valve bank (68) with a cold water inlet (70), a warm water inlet (72), and a mixed water outlet (74), flow-connected to the water outlet (28), a sensor arrangement (18) comprising an operating part (16) and an electronic control (56), which based on electrical signals of the sensor arrangement (18) adjusts the valve bank (68), causing cold water, warm water, or mixed water to be fed with at least one of a desired flowrate value or a desired temperature to the water outlet (28), the operating part (16) comprises a temperature slide (20) that is movable back and forth along a first trajectory (40) as well as a flowrate slide (22) that is movable back and forth along a second trajectory (42) and the sensor arrangement (18) comprises a first sensor (54), which depending on a location of the temperature slide (20) generates a respective electrical temperature signal, as well as a second sensor (60) which depending on a location of the flowrate slide (22) generates a respective electrical flowrate signal, and the electronic control (56), based on the temperature signal and the flowrate signal, adjusts the valve bank (68), or the operating part comprises at least one optic display (330) for illustrating a virtual temperature slide (320) that is movable back and forth along a first trajectory (340) as well as a virtual flowrate slide (324) that is movable back and forth along a second trajectory (342) and the sensor arrangement comprises first touch sensors arranged along the first trajectory which detect finger motions and serve to displace the virtual temperature slide via a first contact motion and which dependent on a location along the first trajectory, at which the first contact motion ends, generate a respective electrical temperature signal as well as second contact sensors arranged along the second trajectory, which detect finger motions which serve to displace the virtual flowrate slide via a second contact motion, and which dependent on a location along the second trajectory, at which the second contact motion ends, generates a respective electrical flowrate signal, and the electronic control (56) based on the temperature signal and the flowrate signal adjusts the valve bank (68).

2. The sanitary fitting according to claim 1, wherein the first sensor (54) as well as the second sensor (60) each comprise at least one Hall-sensor (46) and the temperature slide (20) as well as the flowrate slide (22) each comprise one permanent magnet cooperating with the corresponding Hall-sensor (46).

3. The sanitary fitting according to claim 2, wherein the first sensor (54) as well as the second sensor (60) comprise several Hall-sensors (46), which are respectively arranged in a row (48, 50) in a direction of at least one of the first or the second trajectory (40, 42) behind one another and with the respective permanent magnet (36) cooperating therewith.

4. The sanitary fitting according to claim 3, wherein an electronic circuit (64) which feeds the Hall-sensors (46) with a defined current and amplifies an outlet voltage of the Hall-sensors (46) and forwards them as at least one of the temperature signal [[and/]]or the flowrate signal to the control (56).

5. The sanitary fitting according to claim 1, wherein the operating part (16) comprises a wall (44) which forms on one side guides (38) defining the first and the second trajectory (40, 42) for the temperature slide (20) and the flowrate slide (22), with the first sensor and the second sensor (54, 60) being arranged on the other side of the wall (44).

6. The sanitary fitting according to claim 5, wherein the wall (44) is located in an at least approximately horizontal plane and the guides (38) are formed at the bottom.

7. The sanitary fitting according to claim 1, further comprising a fitting housing (10) jointly allocated to the water outlet (28) and the operating part (16).

8. The sanitary fitting according to claim 7, wherein the fitting housing (10) comprises a base part (12) as well as a separate head part (16) fastened thereto, and a self-contained sealing part (84), cooperating with a lower cover plate (33), is allocated to the head part (16), said sealing element prevents penetration of liquid into an interior of the head part (16), and the sensor arrangement (18) is arranged on the interior of the head part (16) and the temperature slide (20) as well as the flowrate slide (22) are arranged on an exterior of the head part (16) facing the environment.

9. The sanitary fitting according to claim 7, wherein the fitting housing (10) comprises an outlet housing (82) allocated to the water outlet (28) and a separate operating housing (80) allocated to the operating part (16).

10. The sanitary fitting according to claim 9, wherein a self-contained sealing element (84) is allocated to the operating housing (80) and cooperates with the lower cover plate (33), said sealing element prevents penetration of liquid into an interior of the operating housing (80), and the sensor housing (18) is arranged on the interior of the operating housing (80) and the temperature slide (20) as well as the flowrate slide (22) are arranged on an exterior of the operating housing (80) facing the environment.

11. The sanitary fitting according to claim 5, further comprising a fitting housing allocated to the water outlet and the opening part, the fitting housing comprising a base part and a separate head part fastened thereto, the wall (44) is formed by a guide element (49) for the temperature slide (20) and the flowrate slide (22), inserted in an upper cover (51) of the head part (16).

12. The sanitary fitting according to claim 5, further comprising a fitting housing allocated to the water outlet and the opening part, the fitting housing comprising a base part and a separate head part fastened thereto, and the wall (44) is formed by an upper cover (51) of the head part (16).

13. The sanitary fitting according to claim 1, further comprising at least one of a temperature limit (90) to prevent the outflow of mixed water above a predetermined temperature or a flowrate limit to restrict the water flowrate to a predetermined value.

14. A sanitary fitting according to claim 1, wherein an off-position (88) of the flowrate slide (22) is provided at least approximately in a longitudinal center of the second trajectory (42), allowing for the flowrate slide (22), starting from the off-position (88), to be moved in opposite directions and the electronic control (56), based on the flowrate signal obtained from second sensor (6), adjusts the valve bank (68) such that the mixed water is supplied to one or the other of two water outlets (28).

15. The sanitary fitting according to claim 12, further comprising a self-contained sealing part (84), cooperating with a lower cover plate (33), is allocated to the head part (16), said sealing element prevents penetration of liquid into an interior of the head part (16), and the sensor arrangement (18) is arranged on the interior of the head part (16) and the temperature slide (20) as well as the flowrate slide (22) are arranged on an exterior of the head part (16) facing the environment, and a guide element (49) is formed for the temperature slide (20) and the flowrate slide (22), which is inserted in a circumferentially sealing fashion, and a sealing element (84) at one side cooperates with the lower cover plate (33) and on an other side with the guide element (49) in a sealing fashion.
